(19) United States
(12) Patent Application Publication
(10) Pub. No.: US 2020/0368570 A1
(43) Pub. Date: Nov. 26, 2020

(54) SUPPRESSION OF FIRE

(71) Applicant: FireRein Inc., Napanee (CA)

(72) Inventors: ZACKERY MICHAEL HODGEN, Napanee (CA); QUINCY ANDREW EMMONS, Napanee (CA); DAVID JOHN HYNDMAN, Napanee (CA)

(21) Appl. No.: 16/879,099

(22) Filed: May 20, 2020

Related U.S. Application Data
(60) Provisional application No. 62/850,828, filed on May 21, 2019.

(51) Int. Cl. A62D 1/00

(52) U.S. Cl. CPC A62D 1/0064

(57) ABSTRACT

Methods of abating, extinguishing and/or preventing Class B fires comprising applying a hydrogel comprising a biopolymeric thickening agent and a non-biopolymeric thickening agent to the Class B fire are described.

### CROSS REFERENCE TO RELATED APPLICATIONS

This application claims the benefit of U.S. Provisional Patent Application No. 62/850,828, filed May 21, 2019, the disclosure of which is expressly incorporated herein by reference in its entirety.

### FIELD

The present application pertains to the field of firefighting. More particularly, the present application relates to methods of abating, extinguishing and/or preventing Class B fires using hydrogels.

### BACKGROUND

Fire is a threat to life, property, and natural, suburban, and urban landscapes worldwide. Forest, brush, and grassland fires destroy acres of natural and suburban landscapes each year; with the total average of acres lost to wildfire increasing since about 1984. This destruction is not only in terms of a loss of timber, wildlife and livestock, but also in erosion, disruption to watershed equilibria, and related problems in natural environments. In suburban, urban, and industrial areas, fire can result in billions of dollars in damage from loss of lives, property, equipment, and infrastructure; not only from the fire itself, but also from water used to extinguish it.

Fire and its constructs are often described by the ‘Fire Tetrahedron’, which defines heat, oxygen, fuel, and a resultant chain reaction as the four constructs required to produce fire; removing any one will prevent fire from occurring. There are five classes of fire: Class A, which comprises common combustibles, such as wood, cloth, etc.; Class B, which comprises flammable liquids and gases, such as gasoline, solvents, etc.; Class C, which comprises live electrical equipment, such as computers, etc.; Class D, which comprises combustible metals, such as magnesium, lithium, etc.; and, Class K, which comprises cooking media, such as cooking oils and fats.

For Class B fires, which include fires with flammable liquids and gases, such as crude oils, gasoline, jet fuels, alcohols, ethers etc., as a fuel source, firefighting foams are often employed to suppress the fire. Firefighting foams extinguish fires by smothering the fire, thereby preventing oxygen from reaching the combustible material. To this end, many types of firefighting foams have been developed, including firefighting foams formulated with hydrolyzed proteins; and aqueous film-forming foams (AFFF) or alcohol-resistant AFFF (AR-AFFF), which spread an aqueous film on the surface of hydrocarbon liquids when applied.

Despite the success of AFFF and AR-AFFF, there remain problems with such formulations. First, the aqueous film produced often results from the inclusion of fluorochemical surfactants. Fluorocarbons such as those employed are known toxicants and are not readily biodegradable, therefore leaving a toxic residue once the fire is extinguished. Second, the barrier created by AFFF can be fragile. There is a risk of re-flash or auto-ignition if the barrier breaks.

There remains a need for improved methods of abating, extinguishing and/or preventing Class B fires.

### SUMMARY OF THE INVENTION

In one aspect, there is provided a method of suppressing a Class B fire, comprising applying a hydrogel comprising a biopolymeric thickening agent and a non-biopolymeric thickening agent to the Class B fire.

In an embodiment of the method described herein, the hydrogel comprises water or an aqueous solution.

In an embodiment of the method described herein, the non-biopolymeric thickening agent swells at a faster rate when mixed with water or an aqueous solution than the biopolymeric thickening agent.

In an embodiment of the method described herein, the biopolymeric thickening agent comprises at least one polysaccharide, protein, or combination thereof. The polysaccharide may be a starch, a natural gum, an alginate, a chitin, a chitosan, a cellulose, a glycogen, a pectin, a carrageenan, or an agar.

In an embodiment of the method described herein, the non-biopolymeric thickening agent comprises a polymer comprising an acrylic acid, an acrylamide, a vinyl alcohol, a derivative thereof, or a combination thereof.

In an embodiment of the method described herein, the hydrogel comprises at least one of a suspending agent, a surfactant, an emulsifier, a clay, a stabilizer, a freeze point depressant, a preservative, or a pH modifier.

In an embodiment of the method described herein, the hydrogel does not comprise a foaming agent.

### DETAILED DESCRIPTION

The present inventors have now developed methods of suppressing Class B fires using fire-suppressing hydrogels. As detailed below, the presently disclosed methods employ hydrogels that comprise a biopolymeric thickening agent and a non-biopolymeric thickening agent and are optionally free of a foaming agent (e.g., a fluorochemical surfactant). Without being limited by any particular theory, it is expected that hydrogels employed in the methods described herein may create a robust barrier that stays at the surface of a fuel source for a longer period than hydrogels comprising only a non-biopolymeric thickening agent, thereby speeding up the knockdown time. Further, it is expected that the presence of a biopolymeric thickening agent may allow for hydrogels to be formed at a further distance from the fire than hydrogels comprising only a non-biopolymeric thickening agent, thereby making the methods described herein safer for firefighters.

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiment paragraphs herein. The transitional phrase “consisting of” excludes any element, step, or ingredient which is not specifically recited. The transitional phrase “consisting essentially of” limits the scope to the specified elements, materials or steps and to those that do not materially affect the basic characteristic(s) of the invention disclosed and/or claimed herein.

It is to be understood that any numerical value inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “suppressing a Class B fire” includes abating, extinguishing and/or preventing a Class B fire.

As used herein, the term “biopolymer” refers to a polymeric substance occurring in living organisms (e.g., animals, plants, algae, and bacteria) while the term “biopolymeric” describes a substance that is a biopolymer.

As used herein, the term “consumer-grade components” refers to food-grade, personal care-grade, and/or pharmaceutical-grade components. The term “food-grade” is used herein to refer to materials safe for use in food, such that ingestion does not, on the basis of the scientific evidence available, pose a safety risk to the health of the consumer. The term “personal care-grade” is used herein to refer to materials safe for use in topical application such that, topical application does not, on the basis of the scientific evidence available, pose a safety risk to the health of the consumer. The term “pharmaceutical-grade” is used herein to refer to materials safe for use in a pharmaceutical product administered by the appropriate route of administration, such that administration does not, on the basis of the scientific evidence available, pose a safety risk to the health of the consumer. As would be well understood by a person skilled in the art, the consumer-grade components in a composition provided herein are present at levels that would be acceptable for use in food, personal-care products and/or pharmaceuticals.

As used herein, the term “non-toxic” is intended to refer to materials that are non-poisonous, non-hazardous, and not composed of poisonous materials that could harm human health if exposure is limited to moderate quantities and not ingested. Non-toxic is intended to connote harmlessness to humans and animals in acceptable quantities if not ingested and even upon ingestion, does not cause immediate serious harmful effects to the person or animal ingesting the substance. The term non-toxic is not intended to be limited to those materials that are able to be swallowed or injected or otherwise taken in by animals, plants, or other living organisms. The term non-toxic may mean the substance is classified as non-toxic by the Environmental Protection Agency (EPA), the World Health Organization (WHO), the Food and Drug Administration (FDA), Health Canada, or the like. The term non-toxic is therefore not meant to mean non-irritant or not causing irritation when exposed to skin over prolonged periods of time or otherwise ingested.

When used to describe components of hydrogels employed in the methods described herein, the term non-toxic indicates that the components are non-toxic to humans at concentrations and exposure levels required for effective use as fire-abating, extinguishing and/or preventing agents, without the need for protective gear.

As used herein, the term “biodegradable” is intended to refer to a substance that can be degraded or decomposed by the action of a living organism such as plants, algae, bacteria, or fungi. The degradation of a substance could be the substance being broken down physically into smaller pieces or chemically into constituent molecules. The constituent molecules of a biodegradable substance may or may not be metabolised by a living organism such as plants, algae, bacteria or fungi.

The term “room temperature” is used herein to refer to a temperature in the range of from about 20° C. to about 30° C.

The term “surface abrasion(s)” as used herein refers to any deviation from a surface's structural norm, such as, but not limited to, holes, fissures, gaps, gouges, cuts, scrapes, cracks, etc.

As used herein, the term “surface adhesion” refers to the ability of a composition to coat and/or adhere to a surface at any orientation (e.g., vertical cling). In referring to hydrogels employed in the methods described herein, the term “surface adhesion” further refers to the ability of hydrogels employed in the methods described herein to adhere to a surface such that adequate fire abating, extinguishing, and/or protecting properties are afforded as a result of the surface being coated by hydrogels employed in the methods described herein.

### Hydrogel-Forming Compositions

Hydrogels employed in the methods described herein may be prepared from a hydrogel-forming composition comprising a biopolymeric thickening agent and a non-biopolymeric thickening agent. The hydrogel-forming composition may be formulated to be mixed with water or an aqueous solution, to form a hydrogel having fire suppressant or retardant properties. The biopolymeric thickening agent swells at a slower rate when mixed with water or an aqueous solution than the non-biopolymeric thickening agent comprised in the hydrogel-forming composition.

In one embodiment, hydrogels employed in the methods described herein comprise between about 0.01% and about 50% by weight of a hydrogel-forming composition, with the remainder being water or an aqueous solution. In another embodiment, hydrogels employed in the methods described herein comprise between about 1% and about 8% (e.g., between about 1% and about 3%, between about 2% and about 4%, or between about 3% and about 6%), by weight of a hydrogel-forming composition, with the remainder being water or an aqueous solution.

In one embodiment, the hydrogel-forming composition may be a liquid concentrate comprising a biopolymeric thickening agent and a non-biopolymeric thickening agent. The liquid concentrate may be, for example, a solution, a suspension or a slurry. In another embodiment, the liquid concentrate includes less than about 5 wt % water, or less than about 3 wt % water, or less than about 2 wt % water, or less than about 1 wt % water.

In yet another embodiment, a hydrogel-forming composition may comprise additional property modifying additives, as described herein.

### Biopolymeric Thickening Agents

Hydrogels employed in the methods described herein require at least one biopolymeric thickening agent that swells at a slower rate when mixed with water or an aqueous solution than the non-biopolymeric thickening agent comprised in the hydrogel-forming composition. Without being limited by any particular theory, it is expected that the slower swelling rate of the biopolymeric thickening agent may reduce the density of the hydrogel as it is applied to the surface of a Class B fire, thereby extending the time the hydrogel stays at the surface of the fuel source, and may also enable forming the hydrogel at a distance further away from the fire.

Within the context of the present application, suitable biopolymeric thickening agents are selected to provide hydrogels used in the methods provided herein with surface adhesion and heat absorbing capabilities effective for abating, extinguishing and/or preventing Class B fires.

Certain polysaccharides can function as biopolymeric thickening agents. Polysaccharide thickening agents include, but are not limited to, starches, sugar polymers and natural gums.

In one embodiment, the biopolymeric thickening agent may comprise starch. Starch, which is a biodegradable, naturally-sourced polymer, can form gels in the presence of water and heat. Starch-based hydrogels can act as fire retardants due to their high water retaining and surface-adhesion capabilities [Ioanna G. Mandala (2012). Viscoelastic Properties of Starch and Non-Starch Thickeners in Simple Mixtures or Model Food, Viscoelasticity—From Theory to Biological Applications, Dr. Juan De Vicente (Ed.), ISBN: 978-953-51-0841-2, InTech, DOI: 10.5772/50221. Available from: http://www.intechopen.com/books/viscoelasticity-from-theory-to-biological-applications/viscoelastic-properties-of-starch-and-non-starch-thickeners-in-simple-mixtures-or-model-food]. Examples of starches that are viable for use in hydrogels employed in the methods described herein include, but are not limited to, corn starch, wheat starch, arrowroot, potato starch, tapioca, and/or rice starch, or derivatives thereof, which may or may not be naturally sourced. Starches can be modified by cross-linking, pregelatinizing, hydrolysis, acid/base-treating, or heating to modify their structure, leading to alteration of their solubility, swelling, viscosity in solution, or stability.

In another embodiment, the biopolymeric thickening agent may comprise a sugar polymer. Sugar polymers include, for example, agar, sodium alginate, celluloses (such as carboxymethylcellulose), pectin and carrageenan. An example of a cellulosic, hydrogel-forming biopolymeric thickening agent is carboxymethylcellulose sodium salt, which has found use in personal lubricants, toothpastes, and ice creams as a thickener; it is food-grade and biodegradable, and can absorb water at concentrations as low as 1% in water.

In yet another embodiment, the biopolymeric thickening agent may comprise a natural gum. Natural gums, such as, but not limited to, guar gum, xanthan gum, acacia gum (gum arabic), diutan gum, welan gum, gellan gum, and/or locust bean gum, some of which are used as thickeners in food, pharmaceutical and/or cosmetic industries, may also be viable, naturally sourced, biodegradable biopolymeric thickening agents. Polysaccharide gums are polymers of various monosaccharides with multiple branching structures that cause a large increase in the viscosity of a solution. For example, guar gum is a branched polymer of a linear mannose polymer with galactose side-branches, sourced primarily from ground endosperms of guar beans, and reportedly has a greater water-thickening potency than cornstarch; xanthan gum is produced by Xanthomonascamperstris [Tako, M. et al. Carbohydrate Research, 138 (1985) 207-213]; and acacia gum is a branched polymer of arabinose and galactose monosaccharides.

In one embodiment, the biopolymeric thickening agent comprises a blend of a starch and at least one natural gum.

Certain proteins may also function as biopolymeric thickening agents. In one embodiment, the biopolymeric thickening agent may comprise a protein. Protein thickening agents include, but are not limited to, collagen, gelatin, gluten, soy proteins and milk proteins.

### Non-Biopolymeric Thickening Agents

Hydrogels employed in the methods described herein require at least one non-biopolymeric thickening agent that swells at a faster rate when mixed with water, or an aqueous solution than the biopolymeric thickening agent comprised in the hydrogel-forming composition. Within the context of the present application, suitable non-biopolymeric thickening agents are selected to provide hydrogels used in the methods provided herein with surface adhesion and heat absorbing capabilities effective for abating, extinguishing and/or preventing Class B fires. In one embodiment, a non-biopolymeric thickening agent may be capable of absorbing at least 20 times its own weight of water. Without being limited by any particular theory, it is expected that the faster swelling rate of the non-biopolymeric thickening agent may reduce water evaporation as the hydrogel is applied to a Class B fire.

In one embodiment, the non-biopolymeric thickening agent may comprise a cross-linked, water-swellable polymer. Such polymers include a polymer of hydrophilic monomers, such as acrylamide, acrylic acid derivatives, maleic acid anhydride, itaconic acid, 2-hydroxyl ethyl acrylate, polyethylene glycol dimethacrylate, allyl methacrylate, tetraethyleneglycol dimethacrylate, triethyleneglycol dimethacrylate, diethylene glycol dimethacrylate, glycerol dimethacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, 2-acrylamido-2-methylpropanesulfonic acid derivatives, and other hydrophilic monomers.

In another embodiment, a polymer selected from a group of polymers known by their trade designation CARBOPOL™ (generally high molecular weight homo- and copolymers of acrylic acid cross-linked with a polyalkenyl polyether) may be comprised in a non-biopolymeric thickening agent. Such a polymer may be CARBOPOL™ EZ-3, a hydrophobically modified cross-linked polyacrylate powder that is self-wetting, can require low agitation for dispersion, and has a shear thinning rheology, so can be pumped or sprayed onto a surface without the loss of cling.

In yet another embodiment, polyvinyl alcohol, polyvinyl acetate, polyethylene oxide, polypropylene oxide and polyvinylpyrolidone, and the like, used individually or in combination, may be comprised in a non-biopolymeric thickening agent.

In still another embodiment, the non-biopolymeric thickening agent may comprise a co-polymer of acrylamide and acrylic acid derivatives. In still another embodiment, the non-biopolymeric thickening agent may comprise a terpolymer of a salt of acrylate, acrylamide, and a salt of 2-acrylamido-2-methylpropanesulfonic acid (AMPS). The salts may be sodium salts. In still another embodiment, the non-biopolymeric thickening agent comprises a cross-linked polyacrylic acid; a cross-linked, partially neutralized polyacrylic acid; a cross-linked, fully neutralized polyacrylic acid; or a combination thereof.

### Further Characteristics of Hydrogels Employed in the Methods Described Herein

Hydrogels employed in the methods described herein may be sensitive to pH changes. In one embodiment, hydrogels employed in the methods described herein may be pH-sensitive polymeric hydrogels, which become water-soluble or non-gelatinous as a result of a spontaneous, induced, or applied pH change. In another embodiment, a pH-sensitive polymeric hydrogel may comprise poly(vinyl alcohol); poly(vinyl alcohol) cross-linked with borax; chitosan; and/or a polyelectrolyte complex.

Hydrogels employed in the methods described herein may comprise a material that produces carbon dioxide upon exposure to heat. In one embodiment, the material that produces carbon dioxide upon exposure to heat may be urea, a urea derivative or a combination thereof. In another embodiment, the material that produces carbon dioxide upon exposure to heat may comprise (hydroxyalkyl)urea, mono(hydroxyethyl)urea, N,N-bis(2-hydroxyethyl)urea, tetrakis(2-hydroxyethyl)urea, tris(2-hydroxyethyl)urea, N,N-bis(2-hydroxyethyl)urea, N,N-(3-hydroxypropyl)urea, N,N-bis(4-hydroxybutyl)urea, 2-urea-2-ethyl-1,3-propanediol, saccharide ureas, 4,5-dihydroxyethylene urea, or a combination thereof.

### Property Modifying Additives

Other components, or additives, can be added to hydrogels employed in the methods described herein in order to affect or alter one or more properties of the hydrogels. The appropriate additive(s) can be incorporated as required for a particular use. For example, additives can be added to affect the viscosity and/or stability of hydrogels employed in the methods described herein. Additional additives that can be incorporated in hydrogels employed in the methods described herein include, but are not limited to, suspending agents, surfactants, emulsifiers, clays, stabilizers, pH modifiers, binding agents, cross-linking agents, salts, sugars, preservatives, freeze point depressants, anti-microbial agents, antifungal agents and pigments or dyes/coloring agents.

Specific, non-limiting examples of additives include: sodium and magnesium salts (e.g., borax, sodium bicarbonate, sodium sulphate, magnesium sulphate), which can affect hydrogel viscosity and/or stability [Kesavan, S. et al., Macromolecules, 1992, 25,2026-2032; Rochefort, W. E., J. Rheol. 31, 337 (1987)]; chitosan or epsilon polylysine, which can act as anti-microbials [Polimeros: Ciencia e Tecnologia, vol. 19, no 3, p. 241-247, 2009; http://www.fda.gOv/ucm/groups/fdagov-public/@fdagov-foods-gen/documents/document/ucm 267372.pdf (accessed Sep. 26, 2014)]; preservatives such as Proxel™ GXL, Proxel™ BD20, benzoates (such as sodium benzoate and benzoic acid), nitrites (such as sodium nitrite), sulphites (such as sulphur dioxide), and sorbates (such as sodium sorbate and potassium sorbate) and salts thereof; citric acid for modifying pH; potassium acetate and sodium bicarbonate, which can help sequestering Class B (which comprises flammable liquids and gases, such as gasoline, solvents, etc.) or K (which comprises cooking media, such as cooling oils and fats) fires; vegetable oils and lecithin as binding agents; materials that release CO₂ when exposed to heat, such as sodium bicarbonate or monoammonium phosphate; and pectin, which can aid in the formation of hydrogels.

Hydrogel-forming compositions, formed from solid components (e.g., biopolymeric and non-biopolymeric thickening agents) suspended or dissolved in a liquid medium (e.g., vegetable oil), may exhibit settling of solid components over time. If such settling were to occur, the hydrogel-forming composition can be physically agitated in order to re-suspend or re-dissolve its components. Alternatively, a suspending agent (e.g., surfactant or emulsifier), or a combination of suspending agents, can be added to the hydrogel-forming composition to stabilize the hydrogel-forming composition, or to facilitate keeping solid components suspended or dissolved in the liquid medium, either indefinitely, or for a length of time sufficient to maintain the hydrogel-forming compositions utility for forming hydrogels employed in the methods described herein.

Suspending agents may improve the properties of hydrogels employed in the methods described herein as compared to those that do not include the agent, for example, by improving the speed at which hydrogels employed in the methods described herein are formed and/or providing stability and flowability to the hydrogel-forming composition. Suspending agents may be synthetic, naturally-occurring, hydrophilic or organophilic. Non-limiting examples of suspending agents are silica, glycogen particles, clays (e.g., bentonite), organophilically modified clays (e.g., organically modified montmorillonite), water, edible oils, such as nut/seed oils, or vegetable/plant oils, glycerol, low molecular weight polyethylene glycols (PEG), hydrophobic agglomerating materials, or any combination thereof. In one embodiment, the suspending agent may be a vegetable oil. In another embodiment, the suspending agent may be an amorphous silica, such as a fumed silica (for example, an Aerosil®). In yet another embodiment, the suspending agent may be a biodegradable ester oil.

Hydrogels employed in the methods described herein may comprise liquid paraffins or olefins as a hydrophobic agglomerating material. Paraffin is the common name for alkane hydrocarbons with the general formula CₙH₂ₙ₊₂. Liquid paraffins generally have less than 20 carbon atoms. In one embodiment, the paraffin may have from 10 to 18 carbon atoms or 10 to 14 carbon atoms and be linear, or have from 14 to 16 carbon atoms and be a linear alkane. Olefin is the common name for alkene hydrocarbons with the general formula CₙH₂ₙ where the hydrocarbon is not saturated. In one embodiment, the olefin may have from 10 to 18 carbon atoms or 10 to 14 carbon atoms and be linear, or have from 14 to 16 carbon atoms and be a linear alpha olefin. Commercially available paraffins and olefins include BIO-BASE™ 100LF (linear internal olefin with a carbon chain length between C15 and C18), BIO-BASE™ 300 (linear paraffin with a carbon chain length between C11 and C14), and BIO-BASE™ 200 (linear alpha olefin with a carbon chain length between C16 and C18).

Hydrogels employed in the methods described herein may comprise a clay. In one embodiment, the clay is added to a hydrogel-forming composition. A clay may be included in any useful amount and can act as a suspending agent. In another embodiment, the clay may be smectite clay. Commercially available smectite clay is available under the trade designations Bentone™ SD1 and Bentone™ SD3.

Hydrogels employed in the methods described herein may comprise emulsifiers and/or surfactants. Emulsifiers and/or surfactants may improve the swell time of a biopolymeric and/or non-biopolymeric thickening agent (the time to absorb effective quantities of water or an aqueous solution), and ensure that the biopolymeric and non-biopolymeric thickening agents are dispersed relatively evenly throughout hydrogels employed in the methods described herein and/or hydrogel forming composition.

Examples of non-toxic, consumer-grade surfactants and/or emulsifiers include, but are not limited to, lecithins, lysolecithins, polysorbates, sodium caseinates, monoglycerides, fatty acids, fatty alcohols, glycolipids, and/or proteins [Kralova, I., et al. Journal of Dispersion Science and Technology, 30:1363-1383, 2009]. Such surfactants and/or emulsifiers can be provided as solids or liquids. The addition of a surfactant and/or emulsifier, or combination of surfactants and/or emulsifiers, to a hydrogel-forming composition, can increase the viscosity of the hydrogel-forming composition and/or increase the viscosity of hydrogels employed in the methods described herein formed following dilution of the hydrogel-forming composition with water or an aqueous solution. While not wishing to be bound to any particular theory, it is believed that this effect of the surfactant and/or emulsifier, or combination of surfactants and/or emulsifiers, occurs as a result of their suspension action, and/or by increasing the amount of material that can be included in a hydrogel-forming concentration or hydrogels employed in the methods described herein.

In one embodiment, the emulsifier may be a water-insoluble, oil-soluble surface active agent, such as Hypermer 2296.

In another embodiment, the surfactant may be a low hydrophile-lipophile balance (HLB) surfactant. The HLB of a surfactant is a measure of the degree to which it is hydrophilic or lipophilic. HLB values are based on the respective sizes and strengths of the hydrophilic and lipophilic moieties of a surfactant molecule. In one embodiment, the low hydrophile-lipophile balance (HLB) surfactant may be sorbitan monooleate.

In another embodiment, the surfactant may be a non-ionic surfactant. In yet another embodiment, the non-ionic surfactant may be an alkoxylated alcohol non-ionic surfactant, such as Delonic™ LF-EP-61. In still another embodiment, the non-ionic surfactant may be octyl phenyl ethoxylate.

Hydrogels employed in the methods described herein may contain more than one surfactant and/or emulsifier. The surfactant and/or emulsifier may be all solid surfactants and/or emulsifiers, all liquid surfactants and/or emulsifiers, or a combination of liquid and solid surfactants and/or emulsifiers.

Hydrogels employed in the methods described herein may also include a pH modifier. A pH modifier is any material capable of altering the pH when added. In one embodiment, the pH modifier may be an acid that lowers the pH, such as organic acids (e.g. acetic, oxalic, or citric acid) or mineral acids (e.g. hydrochloric acid), or a base that increases the pH, such as organic bases (e.g. triethanolamine) or inorganic bases (e.g. sodium or ammonium hydroxide). In another embodiment, the pH modifier may include an alcohol amine neutralizer such as, for example, an amino-methyl-propanol (e.g., 2-amino-2-methly-1-propanol). One commercially available alcohol amine is AMP-100™.

Hydrogels employed in the methods described herein may comprise freeze point depressants. Freeze point depressants are used to prevent hydrogels employed in the methods described herein and/or hydrogel-forming compositions from freezing. Freeze point depressants include, but are not limited to, glycerol, propylene glycol, sugar, salt, and the like.

Hard water, i.e. water containing various levels of cations, may affect the degree of swelling of a polymer comprised in hydrogels employed in the methods described herein. In one embodiment, hydrogels employed in the methods described herein may comprise a component to counteract this effect. In another embodiment, AMPS or a derivative of AMPS is added to counter the effect of hard water. One skilled in the art would recognize that the amount and nature of the component added may be varied depending on the hardness of the water used.

Cross-linking agents may be used to adjust the viscosity of hydrogels employed in the methods described herein. In one embodiment, hydrogels employed in the methods described herein may comprise a cross-linking agent. Suitable crosslinking agents include, but are not limited to, triethanolamine; alkali metal borates, such as sodium and potassium borates; alkali metal pyroantimonates, such as sodium and potassium pyroantimonates; titanates, such as sodium and potassium fluorotitanates and potassium titanium oxalate; chromates, such as sodium and potassium chromates and dichromates; vanadates, such as ammonium vanadate; and the like.

As would be readily appreciated by a worker skilled in the art, additive(s) can be added to a hydrogel-forming composition used to form hydrogels employed in the methods described herein, or additive(s) can be added during formation of hydrogels employed in the methods described herein, or additive(s) can be added to already formed hydrogels employed in the methods described herein.

### Foaming Agents

Commonly used firefighting foams include foaming agents, reagents used to provide a foaming action and/or to impart persistence to foams generated. For example, synthetic firefighting foams (e.g. AFFF and AR-AFFF) often comprise synthetic surfactants, such as sodium alkyl sulfate, and fluorosurfactants. Protein firefighting foams comprise natural proteins as the foaming agents and can include ferrous sulfate, which is used to help provide a foaming action. In one embodiment, hydrogels employed in the methods described herein do not include a foaming agent, such as those described herein.

One class of foaming agents is foam generators. An example of a foam generator is a combination of an acid and base. Foam generators include sodium bicarbonate and citric acid, and octenyl succinic anhydride or dodecenyl succinic anhydride modified starches, dextrins and flour. Other base foam generators may include, but are not limited to, potassium bicarbonate, calcium carbonate, urea-base potassium bicarbonate and potassium chloride, along with an acid.

Perfluoroalkyl surfactants/fluorosurfactants (e.g. fluorotelomers, perfluorooctanoic acid (PFOA), or perfluorooctanesulfonic acid (PFOS)) are well-known foaming agents. Such foaming agents include reagents disclosed in EP 206548A (e.g. C₈F₁₇ SO₃ K, C₆F₁₃SO₂N(CH₂ CH(OH)CH₂SO₃⁻)C₃H₆ N+(CH₃)₂C₂H₄OH, and C₆F₁₃SO₂N(C₃H₆SO₃⁻) C₃H₆N⁺(CH₃)₂C₂H₄OH).

Low water content alkyl polyglycosides, such as Triton™ BG-10 or AL 2575, are also known to act as high-foaming surfactants in compositions not comprising perfluoroalkyl surfactants (see EP0936938).

Known foaming agents also include synthetic or natural organic compounds or materials capable of foaming water, such as: soaps or the salts of fatty acids, such as those having the general formula RCOOM, where R is a fatty aliphatic group and M is an alkali metal, e.g., sodium oleate, laurate, palmitate, or stearate; fatty alkyl sulfates, such as those of the general formula ROSO₂OM, e.g., sodium octyl, decyl, lauryl, tetradecyl, hexadecyl, heptadecyl, or octadecyl sulfate; salts of alkarylsulfonic acids, such as those of the general formula RC₆H₄SO₃M, e.g., sodium octylbenzene sulfonate; ethylene oxide adducts, such as those of the general formula R(CH₂CH₂O)ₙ H where R is a fatty aliphatic radical, e.g., where R is C₁₀H₂₁O to C₁₆H₃₃O and n is 10 to 60; those of the general formula R(OCH₂CH₂)ₙOSO₃M, where R is a C₁₀ to C₁₈ alkyl, n is 1 to 3, and M is sodium; and salts of dialkyl Sulfosuccinic acids, e.g., sodium dioctyl sulfosuccinate.

Foaming agents further include foam stabilizers, such as ethylene glycol, diethylene glycol, glycerol, ethyl CELLOSOLVE®, and butyl CARBITOL®; foam tougheners and shrink control agents, such as aqueous rubber or polymeric latices, e.g. styrene-butadiene rubber latices, poly(chloroprene) rubber latices, poly(chloroprene-co-methacrylic acid) rubber latices, and the polymer latices described in U.S. Pat. No. 4,315,703.

### Hydrogel Formation and Application

When applied using firefighting equipment, a hydrogel-forming composition is mixed with the equipment's supply of water or an aqueous solution or mixed with water or an aqueous solution in a reservoir, and then applied to target objects (such as, structures, edifices and/or landscape elements) to extinguish, abate or prevent fire or to protect the target objects from fire. Hydrogels employed in the methods described herein are often prepared in bulk, but can also be prepared using an appropriate on demand system, such as an inductor, an eductor or an injection system, for example, a solid phase educator (e.g., the dry inductor from Pattison, the Cleanload™ chemical inductor from Dultmeier, or a Handler™ chemical handling system from Polywest).

Firefighting equipment useful in applying hydrogels employed in the methods described herein comprises means for spraying, or otherwise applying, the resultant hydrogels employed in the methods described herein onto the target objects. In one embodiment, the firefighting equipment additionally comprises a means for mixing a hydrogel-forming composition with water or an aqueous solution and a reservoir for holding the hydrogel-forming composition until required; the reservoir being in fluid communication with the mixing means such that the hydrogel-forming composition can be moved from the reservoir to the mixing means for mixing with the water or aqueous solution. In another embodiment, the firefighting equipment additionally comprises means for introducing water or an aqueous solution to the means for mixing, or a reservoir fluidly connected to the means for mixing, such that the water or aqueous solution can be moved from the reservoir to the mixing means for mixing with a hydrogel-forming composition.

Non-limiting examples of firefighting equipment suitable for application of hydrogels employed in the methods described herein prepared from a hydrogel-forming composition include fire extinguishers (e.g., an air over water extinguisher), spray nozzle-equipped backpacks, or sprinkler systems. The firefighting equipment can be mounted on or in a vehicle, such as, a truck, airplane or helicopter.

In one embodiment, in which hydrogels employed in the methods described herein are used for abating, extinguishing and/or preventing Class B fires using fire trucks, or other firefighting vehicles, including aircrafts, hydrogels employed in the methods described herein are formed and used via the following, non-limiting process: a hydrogel-forming composition is added to a vehicle's water-filled dump tank and/or other portable tank, and mixed with the water via a circulating hose, or equivalent thereof; hydrogels employed in the methods described herein, once formed, are pumped out of the tank(s), and hydrogels employed in the methods described herein are applied to the target objects (e.g., edifices or landscape elements), via a hard suction hose, or equipment equivalent thereof.

In another embodiment, a hydrogel-forming composition is added directly to a vehicle's onboard water tank, either manually or via an injection system, and mixed by agitation with optional recirculation/overpumping in the tank. In one example of this embodiment, the injection system comprises an ‘after the pump’ system that injects specified amounts of the hydrogel-forming composition into water that has passed through the vehicle's pump, and is about to enter the fire hose; friction of, or the shear forces caused by, the water moving through the hose assists in mixing the hydrogel-forming composition with the water to produce hydrogels employed in the methods described herein in the hose. In another specific example, the injection system pumps the hydrogel-forming composition from a dedicated reservoir to an injection pipe that introduces the hydrogel-forming composition into the water just prior to the hose line; a computerized system calculates water flow via a flow meter on said injection pipe to inject required amounts of the composition into the pipe and hose stream via a specially designed quill.

In another embodiment, a hydrogel-forming composition is metered into the water stream before the pump or proportioned via use of an eductor.

Firefighting vehicles suitably equipped with an in-line injection system, allow a hydrogel-forming composition to be added directly in-line with the water, which can then be mixed via physical agitation and/or shear forces within the hose itself.

For hydrogels that comprise only non-biopolymeric thickening agents, e.g. those using only polyacrylate and/or polyacrylamide-based non-biopolymeric thickening agents, the mixing/proportionating must occur at the nozzle due to the rate at which the hydrogel forms when mixed with water or an aqueous solution. As hydrogels employed in the methods described herein comprise both a biopolymeric thickening agent and a non-biopolymeric thickening agent, and because the biopolymeric thickening agent and the non-biopolymeric thickening agent may swell at different rates when mixed with water or an aqueous solution, the mixing/proportionating may occur away from the nozzle. In one embodiment, the mixing/proportionating may occur up to 500 ft from the nozzle.

As would be readily appreciated by a worker skilled in the art, although the methods for forming hydrogels employed in the methods described herein described above specifically refer to a firefighting truck, such methods are equally applicable to abating, extinguishing and/or preventing Class B fires using aircraft, such as airplanes or helicopters, where hydrogels employed in the methods described herein are formed and then air dropped from the aircraft.

In another embodiment, hydrogels employed in the methods described herein are made from a hydrogel-forming composition at the time of abating, extinguishing and/or preventing Class B fires using firefighting backpacks. In this embodiment the hydrogel-forming composition can be added directly to the backpack's water-filled reservoir, and manually or mechanically shaken to form hydrogels employed in the methods described herein. Once formed, hydrogels employed in the methods described herein can be applied to requisite objects, or surfaces, via the backpacks' spray-nozzles.

In another embodiment, a hydrogel-forming composition can be added to a sprinkler system's water supply, such that, upon activation as a result of heat, smoke, and/or fire detection, the system sprays hydrogels employed in the methods described herein rather than simply water (as in current practice). In one embodiment, once a sprinkler system is activated, a dedicated pump system injects the hydrogel-forming composition into the sprinkler's water system, producing hydrogels employed in the methods described herein with properties compatible with the sprinkler's flow requirements, prior to being applied to an object or area (e.g., an edifice, room or landscape area). In another embodiment, the sprinkler system comprises sprinkler heads designed to provide an optimized spray pattern for applying hydrogels employed in the methods described herein to an object or area (e.g., an edifice, room or landscape area).

In yet another embodiment, a sprinkler system for applying hydrogels employed in the methods described herein comprises: a dedicated pump for injecting a hydrogel-forming composition into the sprinkler's water system or for drawing the hydrogel-forming composition into the sprinkler system's water stream; a sprinkler head designed to provide an optimized spray pattern for application of hydrogels employed in the methods described herein; a computerized system to calculate water and/or hydrogel flow; a flow meter to detect water flow in dry pipes; and, a point of injection designed to introduce the hydrogel-forming composition into the water in such a way that is compatible with the sprinkler system and its intended use.

### Properties of Hydrogels Employed in the Methods Described Herein

Hydrogels employed in the methods described herein, as formed from a hydrogel-forming composition, are suitable for use as agents to abate, extinguish and/or prevent Class B fires due to their physical and/or chemical properties. Hydrogels employed in the methods described herein are more viscous than water, and generally resist evaporation, run-off, and/or burning when exposed to high temperature conditions (e.g., fire), due to their water-absorbing, viscosity-increasing components. Hydrogels employed in the methods described herein also exhibit shear-thinning, thixotropic, pseudoplastic, and/or non-Newtonian fluidic behaviour, such that their viscosity decreases when they are subjected to stresses, such as, but not limited to, shear stresses, wherein their viscosity increases again when those stresses are removed.

Consequently, once formed, hydrogels employed in the methods described herein can be sprayed via hoses and/or spray-nozzles onto burning objects (e.g., edifices or landscape elements) in a manner similar to water; and, once hydrogels employed in the methods described herein are no longer subjected to the stresses of being sprayed, their viscosity will increase to be greater than that of water. As a result, hydrogels employed in the methods described herein coat and cling, at virtually any angle, to surfaces they are applied to, allowing them to extinguish fires by displacing oxygen and cooling surfaces, prevent fire flash-over, and/or further protect surfaces from re-ignition via their general resistance to evaporation, run-off, and/or burning.

Further, as the viscosity increase would not be instantaneous, hydrogels employed in the methods described herein can ‘creep’ or ‘Ooze’ into surface abrasions or structural gaps, such as, but not limited to, cracks, holes, fissures, etc., in an edifice or landscape element, coating and protecting surfaces that would otherwise be difficult to protect with water, or other fire-abating, extinguishing and/or preventing agents such as firefighting foams, due to evaporation or run-off. This will contribute an element of penetrative firefighting to a firefighter's arsenal: once the viscosity of hydrogels employed in the methods described herein has increased, it will form a protective layer in, on, under and/or around said cracks, surface abrasions, structural gaps or the like. Also, use of hydrogels employed in the methods described herein can minimize water damage to surfaces, since use of hydrogels employed in the methods described herein would replace the direct use of water in abating, extinguishing and/or preventing fires.

### METHOD OF USE

The methods of suppressing a Class B fire described herein comprise applying hydrogels employed in the methods described herein to the Class B fire. In one embodiment of the methods described herein, the initial burst created when firefighting equipment used to apply hydrogels employed in the methods described herein is opened is used to push heat off of the combustible material. Hydrogels employed in the methods described herein are then applied directly to the combustible material until the fire is suppressed.

### EMBODIMENTS

Particular embodiments of the invention include, without limitation, the following:
1. A method of suppressing a class B fire, comprising applying a hydrogel comprising a biopolymeric thickening agent and a non-biopolymeric thickening agent to the class B fire.
2. The method of embodiment 1, wherein the hydrogel comprises water or an aqueous solution.
3. The method of embodiment 2, wherein the non-biopolymeric thickening agent swells at a faster rate when mixed with water or an aqueous solution than the biopolymeric thickening agent.
4. The method of any one of embodiments 1-3, wherein the biopolymeric thickening agent comprises at least one polysaccharide, protein, or combination thereof.
5. The method of embodiment 4, wherein the polysaccharide is a starch, a natural gum, an alginate, a chitin, a chitosan, a cellulose, a glycogen, a pectin, a carrageenan, or an agar.
6. The method of any one of embodiments 1-5, wherein the non-biopolymeric thickening agent comprises a polymer comprising an acrylic acid, an acrylamide, a vinyl alcohol, a derivative thereof, or a combination thereof.
7. The method of any one of embodiments 1-6, wherein the hydrogel comprises at least one of a suspending agent, a surfactant, an emulsifier, a clay, a stabilizer, a freeze point depressant, a preservative, or a pH modifier.
8. The method of any one of embodiments 1-7, wherein the hydrogel does not comprise a foaming agent.
9. The method of any one of embodiments 1-8, wherein the hydrogel is prepared from a liquid concentrate comprising:
   the non-biopolymeric thickening agent, wherein the non-biopolymeric thickening agent comprises a polymer of at least one hydrophilic monomer;
   the biopolymeric thickening agent;
   a liquid medium; and
   the emulsifier.
10. The method of embodiment 9, wherein the non-biopolymeric thickening agent comprises a co-polymer of acrylamide and an acrylic acid derivative, maleic acid anhydride, itaconic acid, 2-hydroxy ethyl acrylate, polyethylene glycol dimethacrylate, allyl methacrylate, tetraethyleneglycol dimethacrylate, triethyleneglycol dimethacrylate, diethleneglycol dimethacrylate, glycerol dimethacrylate, hydroxypropyl methacrylate, 2-hydroxyethyl methacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, or a AMPS derivative.
11. The method of embodiment 9, wherein the non-biopolymeric thickening agent comprises a copolymer of acrylamide and an acrylic acid derivative.
12. The method of embodiment 9, wherein the non-biopolymeric thickening agent comprises a polymer of at least one of a salt of acrylate and acrylamide.
13. The method of embodiment 9, wherein the non-biopolymeric thickening agent comprises a terpolymer of an acrylate salt, acrylamide and a AMPS salt.
14. The method of any one of embodiments 9-13, wherein the emulsifier is Hypermer 2296.
15. The method of any one of embodiments 9-14, wherein the liquid medium is a water/oil emulsion.
16. The method of any one of embodiments 9-15, wherein the liquid concentrate comprises:
   about 28% the non-biopolymeric thickening agent and biopolymeric thickening agent;
   about 43% water;
   about 23% biodegradable ester oils; and
   about 6% emulsifier.
17. The method of any one of embodiments 9-16, wherein the hydrogel comprises 2-acrylamido-2-methylpropanesulfonic acid or a derivative thereof.
18. The method of any one of embodiments 9-17, wherein the hydrogel comprises about 0.01 wt % to about 50 wt % of the liquid concentrate and about 50 wt % to about 99.99 wt % of water.
19. The method of any one of embodiments 9-18, wherein the hydrogel comprises about 1 wt % to about 2 wt % of the liquid concentrate and about 98 wt % to about 99 wt % of water.
20. The method of any one of embodiments 1-8, wherein the hydrogel is prepared from a liquid concentrate comprising:
   the non-biopolymeric thickening agent;
   the biopolymeric thickening agent, wherein the biopolymeric thickening agent is a food-grade biopolymeric thickening agent;
   an edible oil;
   the surfactant, wherein the surfactant is a low HLB surfactant; and
   the suspending agent.
21. The method of embodiment 20, wherein the non-biopolymeric thickening agent comprises a copolymer of acrylamide and an acrylic acid derivative.
22. The method of embodiment 20, wherein the non-biopolymeric thickening agent comprises a terpolymer of an acrylate salt, acrylamide, and a 2-acrylamido-2-methylpropanesulfonic acid (AMPS) salt.
23. The method of any one of embodiments 20-22, wherein the edible oil is vegetable oil.
24. The method of any one of embodiments 20-23, wherein the low HLB surfactant is sorbitan monooleate.
25. The method of any one of embodiments 20-24, wherein the suspending agent is fumed silica.
26. The method of any one of embodiments 20-25, wherein the liquid concentrate further comprises a food-grade stabilizer.
27. The method of any one of embodiments 20-26, wherein the hydrogel comprises about 0.01 wt % to about 25 wt % of the liquid concentrate and about 75 wt % to about 99.99 wt % of water.
28. The method of any one of embodiments 20-27, wherein the hydrogel comprises about 1 wt % to about 3 wt % of the liquid concentrate and about 97 wt % to about 99 wt % of water.
29. The method of any one of embodiments 1-8, wherein the hydrogel is prepared from a liquid concentrate comprising:
   0.1-20 wt % the biopolymeric thickening agent, wherein the biopolymeric thickening agent is starch;
   30-40 wt % the non-biopolymeric thickening agent;
   30-50 wt % a C₁₀₋₁₈ paraffin or a C₁₀₋₁₈ olefin;
   0.5-5 wt % the surfactant, wherein the surfactant is a non-ionic surfactant; and
   5-10 wt % the pH modifier, wherein the pH modifier is an alcohol amine neutralizer.
30. The method of embodiment 29, wherein the liquid concentrate comprises a clay.
31. The method of embodiment 29 or 30, wherein the liquid concentrate comprises 10-15 wt % starch.
32. The method of any one of embodiments 29-31, wherein the liquid concentrate comprises 33-38 wt % the non-biopolymeric thickening agent, wherein the non-biopolymeric thickening agent comprises an acrylic acid copolymer cross linked with a polyalkenyl polyether.
33. The method of any one of embodiments 29-32, wherein the liquid concentrate comprises 35-45 wt % C₁₄₋₁₆ paraffin or C₁₄₋₁₆ olefin.
34. The method of embodiment 33, wherein the C₁₄₋₁₆ paraffin is a C₁₄ to C₁₆ linear alkane or the C₁₄₋₁₆ olefin comprises a C₁₄ to C₁₆ linear alpha olefin.
35. The method of any one of embodiments 29-34, wherein the liquid concentrate comprises 0.5-2 wt % non-ionic surfactant comprising alkoxylated alcohol non-ionic surfactant.
36. The method of any one of embodiments 29-35, wherein the liquid concentrate comprises 5-10 wt % alcohol amine neutralizer comprising 2-amino-2-methly-1-propanol.
37. The method of any one of embodiments 30-36, wherein the liquid concentrate comprises 0.1-2.5 wt % the clay, wherein the clay is smectite clay.
38. The method of any one of embodiments 29-37, wherein the liquid concentrate comprises less than 5 wt % water.
39. The method of any one of embodiments 29-38, wherein the hydrogel comprises 0.05 to 10 wt % of the liquid concentrate and 90-99.95 wt % of water.
40. The method of any one of embodiments 30-38, wherein the hydrogel is prepared from a liquid concentrate comprising:
   10-15 wt % the biopolymeric thickening agent, wherein the biopolymeric thickening agent is starch;
   33-38 wt % the non-biopolymeric thickening agent, wherein the non-biopolymeric thickening agent comprises an acrylic acid copolymer cross linked with a polyalkenyl polyether;
   35-45 wt % C₁₄₋₁₆ paraffin or C₁₄₋₁₆ olefin;
   0.5-2 wt % the surfactant, wherein the surfactant is a non-ionic surfactant comprising alkoxylated alcohol non-ionic surfactant;
   5-10 wt % the pH modifier, wherein the pH modifier is an alcohol amine neutralizer comprising 2-amino-2-methly-1-propanol; and
   0.1-2.5 wt % the clay, wherein the clay is smectite clay.
41. The method of embodiment 40, wherein the hydrogel comprises 0.05 to 10 wt % of the liquid concentrate and 90-99.95 wt % of water.
42. The method of any one of embodiments 1-8, wherein the hydrogel is prepared from a liquid concentrate comprising a hydrogel-forming polymer composition comprising the biopolymeric thickening agent and the non-biopolymeric thickening agent, wherein the hydrogel forming polymer composition is capable of absorbing at least 20 times its own weight of water.
43. The method of embodiment 42, wherein the non-biopolymeric thickening agent comprises a cross-linked polyacrylic acid; a cross-linked, partially neutralized polyacrylic acid; a cross-linked, fully neutralized polyacrylic acid; or a combination thereof.
44. The method of embodiment 42 or 43, wherein the biopolymeric thickening agent comprises at least one polysaccharide, protein, or combination thereof.
45. The method of any one of embodiments 42-44, wherein the hydrogel is a pH-sensitive polymeric hydrogel, which becomes water-soluble or non-gelatinous as a result of a spontaneous, induced, or applied pH change.
46. The method of embodiment 45, wherein the pH-sensitive polymeric hydrogel comprises poly(vinyl alcohol).
47. The method of embodiment 45, wherein the pH-sensitive polymeric hydrogel comprises poly(vinyl alcohol) crosslinked with borax.
48. The method of embodiment 45, wherein the pH-sensitive hydrogel comprises chitosan.
49. The method of embodiment 45, wherein the pH-sensitive hydrogel comprises a polyelectrolyte complex.
50. The method of any one of embodiments 42-49, wherein the hydrogel comprises a material that produces carbon dioxide upon exposure to heat, wherein the material that produces carbon dioxide comprises urea, a urea derivative or a combination thereof.
51. The method of embodiment 50, wherein the material that produces carbon dioxide comprises (hydroxyalkyl)urea, mono(hydroxyethyl)urea, N,N-bis(2-hydroxyethyl)urea, tetrakis(2-hydroxyethyl)urea, tris(2-hydroxyethyl)urea, N,N-bis(2-hydroxyethyl)urea, N,N-(3-hydroxypropyl)urea, N,N-bis(4-hydroxybutyl)urea, 2-urea-2-ethyl-1,3-propanediol, saccharide ureas, 4,5-dihydroxyethylene urea, or a combination thereof.
52. The method of any one of embodiments 42-51, wherein the hydrogel comprises about 0.01 wt % to about 25 wt % of the liquid concentrate and about 75 wt % to about 99.99 wt % of water.
53. The method of any one of embodiments 42-52, wherein the hydrogel comprises about 0.1 wt % to about 2.5 wt % of the liquid concentrate and about 97.5 wt % to about 99.9 wt % of water.
54. Use of a hydrogel, the hydrogel comprising a biopolymeric thickening agent and a non-biopolymeric thickening agent, for suppressing a class B fire.
55. The use of embodiment 54, wherein the hydrogel comprises water or an aqueous solution.
56. The use of embodiment 55, wherein the non-biopolymeric thickening agent swells at a faster rate when mixed with water or an aqueous solution than the biopolymeric thickening agent
57. The use of any one of embodiments 54-56, wherein the biopolymeric thickening agent comprises at least one polysaccharide, protein, or combination thereof.
58. The use of embodiment 57, wherein the polysaccharide is a starch, a natural gum, an alginate, a chitin, a chitosan, a cellulose, a glycogen, a pectin, a carrageenan, or an agar.
59. The use of any one of embodiments 54-58, wherein the non-biopolymeric thickening agent comprises a polymer comprising an acrylic acid, an acrylamide, a vinyl alcohol, a derivative thereof, or a combination thereof.
60. The use of any one of embodiments 54-59, wherein the hydrogel comprises at least one of a suspending agent, a surfactant, an emulsifier, a clay, a stabilizer, a freeze point depressant, a preservative, or a pH modifier.
61. The use of any one of embodiments 54-60, wherein the hydrogel does not comprise a foaming agent.
62. The use of any one of embodiments 54-61, wherein the hydrogel is prepared from a liquid concentrate comprising:
   the non-biopolymeric thickening agent, wherein the non-biopolymeric thickening agent comprises a polymer of at least one hydrophilic monomer;
   the biopolymeric thickening agent;
   a liquid medium; and
   the emulsifier.
63. The use of embodiment 62, wherein the non-biopolymeric thickening agent comprises a co-polymer of acrylamide and an acrylic acid derivative, maleic acid anhydride, itaconic acid, 2-hydroxy ethyl acrylate, polyethylene glycol dimethacrylate, allyl methacrylate, tetraethyleneglycol dimethacrylate, triethyleneglycol dimethacrylate, diethleneglycol dimethacrylate, glycerol dimethacrylate, hydroxypropyl methacrylate, 2-hydroxyethyl methacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, or a 2-acrylamido-2-methylpropanesulfonic acid (AMPS) derivative.
64. The use of embodiment 62, wherein the non-biopolymeric thickening agent comprises a copolymer of acrylamide and an acrylic acid derivative.
65. The use of embodiment 62, wherein the non-biopolymeric thickening agent comprises a polymer of at least one of a salt of acrylate and acrylamide.
66. The use of embodiment 62, wherein the non-biopolymeric thickening agent comprises a terpolymer of an acrylate salt, acrylamide and a 2-acrylamido-2-methylpropanesulfonic acid (AMPS) salt.
67. The use of any one of embodiments 62-66, wherein the emulsifier is Hypermer 2296.
68. The use of any one of embodiments 62-67, wherein the liquid medium is a water/oil emulsion.
69. The use of any one of embodiments 62-68, wherein the liquid concentrate comprises:
   about 28% the non-biopolymeric thickening agent and biopolymeric thickening agent;
   about 43% water;
   about 23% biodegradable ester oils; and
   about 6% emulsifier.
70. The use of any one of embodiments 62-69, wherein the hydrogel comprises 2-acrylamido-2-methylpropanesulfonic acid or a derivative thereof.
71. The use of any one of embodiments 62-70, wherein the hydrogel comprises about 0.01 wt % to about 50 wt % of the liquid concentrate and about 50 wt % to about 99.99 wt % of water.
72. The use of any one of embodiments 62-71, wherein the hydrogel comprises about 1 wt % to about 2 wt % of the liquid concentrate and about 98 wt % to about 99 wt % of water.
73. The use of any one of embodiments 54-61, wherein the hydrogel is prepared from a liquid concentrate comprising:
   the non-biopolymeric thickening agent;
   the biopolymeric thickening agent, wherein the biopolymeric thickening agent is a food-grade biopolymeric thickening agent;
   an edible oil;
   the surfactant, wherein the surfactant is a low HLB surfactant; and
   the suspending agent.
74. The use of embodiment 73, wherein the non-biopolymeric thickening agent comprises a copolymer of acrylamide and an acrylic acid derivative.
75. The use of embodiment 73, wherein the non-biopolymeric thickening agent comprises a terpolymer of an acrylate salt, acrylamide, and a 2-acrylamido-2-methylpropanesulfonic acid (AMPS) salt.
76. The use of any one of embodiments 73-75, wherein the edible oil is vegetable oil.
77. The use of any one of embodiments 73-76, wherein the low HLB surfactant is sorbitan monooleate.
78. The use of any one of embodiments 73-77, wherein the suspending agent is fumed silica.
79. The use of any one of embodiments 73-78, wherein the liquid concentrate further comprises a food-grade stabilizer.
80. The use of any one of embodiments 73-79, wherein the hydrogel comprises about 0.01 wt % to about 25 wt % of the liquid concentrate and about 75 wt % to about 99.99 wt % of water.
81. The use of any one of embodiments 73-80, wherein the hydrogel comprises about 1 wt % to about 3 wt % of the liquid concentrate and about 97 wt % to about 99 wt % of water.
82. The use of any one of embodiments 54-61, wherein the hydrogel is prepared from a liquid concentrate comprising:
   0.1-20 wt % the biopolymeric thickening agent, wherein the biopolymeric thickening agent is starch;
   30-40 wt % the non-biopolymeric thickening agent;
   30-50 wt % a C₁₀₋₁₈ paraffin or a C₁₀₋₁₈ olefin;
   0.5-5 wt % the surfactant, wherein the surfactant is a non-ionic surfactant; and
   5-10 wt % the pH modifier, wherein the pH modifier is an alcohol amine neutralizer.
83. The use of embodiments 82, wherein the liquid concentrate comprises a clay.
84. The use of embodiments 82 or 83, wherein the liquid concentrate comprises 10-15 wt % starch.
85. The use of any one of embodiments 82-84, wherein the liquid concentrate comprises 33-38 wt % the non-biopolymeric thickening agent, wherein the non-biopolymeric thickening agent comprises an acrylic acid copolymer cross linked with a polyalkenyl polyether.
86. The use of any one of embodiments 82-85, wherein the liquid concentrate comprises 35-45 wt % C₁₄₋₁₆ paraffin or C₁₄₋₁₆ olefin.
87. The use of embodiment 86, wherein the C₁₄₋₁₆ paraffin is a C₁₄ to C₁₆ linear alkane or the C₁₄₋₁₆ olefin comprises a C₁₄ to C₁₆ linear alpha olefin.
88. The use of any one of embodiments 82-87, wherein the liquid concentrate comprises 0.5-2 wt % non-ionic surfactant comprising alkoxylated alcohol non-ionic surfactant.
89. The use of any one of embodiments 82-88, wherein the liquid concentrate comprises 5-10 wt % alcohol amine neutralizer comprising 2-amino-2-methly-1-propanol.
90. The use of any one of embodiments 83-89, wherein the liquid concentrate comprises 0.1-2.5 wt % the clay, wherein the clay is smectite clay.
91. The use of any one of embodiments 82-90, wherein the liquid concentrate comprises less than 5 wt % water.
92. The use of any one of embodiments 82-91, wherein the hydrogel comprises 0.05 to 10 wt % of the liquid concentrate and 90-99.95 wt % of water.
93. The use of any one of embodiments 83-92, wherein the hydrogel is prepared from a liquid concentrate comprising:
   10-15 wt % the biopolymeric thickening agent, wherein the biopolymeric thickening agent is starch;
   33-38 wt % the non-biopolymeric thickening agent, wherein the non-biopolymeric thickening agent comprises an acrylic acid copolymer cross linked with a polyalkenyl polyether;
   35-45 wt % C₁₄₋₁₆ paraffin or C₁₄₋₁₆ olefin;
   0.5-2 wt % the surfactant, wherein the surfactant is a non-ionic surfactant comprising alkoxylated alcohol non-ionic surfactant;
   5-10 wt % the pH modifier, wherein the pH modifier is an alcohol amine neutralizer comprising 2-amino-2-methly-1-propanol; and
   0.1-2.5 wt % the clay, wherein the clay is smectite clay.
94. The use of embodiment 93, wherein the hydrogel comprises 0.05 to 10 wt % of the liquid concentrate and 90-99.95 wt % of water.
95. The use of any one of embodiments 54-61, wherein the hydrogel is prepared from a liquid concentrate comprising a hydrogel-forming polymer composition comprising the biopolymeric thickening agent and the non-biopolymeric thickening agent, wherein the hydrogel forming polymer composition is capable of absorbing at least 20 times its own weight of water.
96. The use of embodiment 95, wherein the non-biopolymeric thickening agent comprises a cross-linked polyacrylic acid; a cross-linked, partially neutralized polyacrylic acid; a cross-linked, fully neutralized polyacrylic acid; or a combination thereof.
97. The use of embodiment 95 or 96, wherein the biopolymeric thickening agent comprises at least one polysaccharide, protein, or combination thereof.
98. The use of any one of embodiments 95-97, wherein the hydrogel is a pH-sensitive polymeric hydrogel, which becomes water-soluble or non-gelatinous as a result of a spontaneous, induced, or applied pH change.
99. The use of embodiment 98, wherein the pH-sensitive polymeric hydrogel comprises poly(vinyl alcohol).
100. The use of embodiment 98, wherein the pH-sensitive polymeric hydrogel comprises poly(vinyl alcohol) crosslinked with borax.
101. The use of embodiment 98, wherein the pH-sensitive hydrogel comprises chitosan.
102. The use of embodiment 98, wherein the pH-sensitive hydrogel comprises a polyelectrolyte complex.
103. The use of any one of embodiments 95-102, wherein the hydrogel comprises a material that produces carbon dioxide upon exposure to heat, wherein the material that produces carbon dioxide comprises urea, a urea derivative or a combination thereof.
104. The use of embodiment 103, wherein the material that produces carbon dioxide comprises (hydroxyalkyl)urea, mono(hydroxyethyl)urea, N,N-bis(2-hydroxyethyl)urea, tetrakis(2-hydroxyethyl)urea, tris(2-hydroxyethyl)urea, N,N-bis(2-hydroxyethyl)urea, N,N-(3-hydroxypropyl)urea, N,N-bis(4-hydroxybutyl)urea, 2-urea-2-ethyl-1,3-propanediol, saccharide ureas, 4,5-dihydroxyethylene urea, or a combination thereof.
105. The use of any one of embodiments 95-104, wherein the hydrogel comprises about 0.01 wt % to about 25 wt % of the liquid concentrate and about 75 wt % to about 99.99 wt % of water.
106. The use of any one of embodiments 95-105, wherein the hydrogel comprises about 0.1 wt % to about 2.5 wt % of the liquid concentrate and about 97.5 wt % to about 99.9 wt % of water.

1. A method of suppressing a Class B fire, comprising applying a hydrogel comprising a biopolymeric thickening agent and a non-biopolymeric thickening agent to the Class B fire.

2. The method of claim 1, wherein the hydrogel comprises water or an aqueous solution.

3. The method of claim 2, wherein the non-biopolymeric thickening agent swells at a faster rate when mixed with water or an aqueous solution than the biopolymeric thickening agent.

4. The method of claim 1, wherein the biopolymeric thickening agent comprises at least one polysaccharide, protein, or combination thereof.

5. The method of claim 4, wherein the polysaccharide is a starch, a natural gum, an alginate, a chitin, a chitosan, a cellulose, a glycogen, a pectin, a carrageenan, or an agar.

6. The method of claim 1, wherein the non-biopolymeric thickening agent comprises a polymer comprising an acrylic acid, an acrylamide, a vinyl alcohol, a derivative thereof, or a combination thereof.

7. The method of claim 1, wherein the hydrogel comprises at least one of a suspending agent, a surfactant, an emulsifier, a clay, a stabilizer, a freeze point depressant, a preservative, or a pH modifier.

8. The method of claim 1, wherein the hydrogel does not comprise a foaming agent.

9. The method of claim 1, wherein the non-biopolymeric thickening agent comprises a co-polymer of acrylamide and an acrylic acid derivative, maleic acid anhydride, itaconic acid, 2-hydroxy ethyl acrylate, polyethylene glycol dimethacrylate, allyl methacrylate, tetraethyleneglycol dimethacrylate, triethyleneglycol dimethacrylate, diethleneglycol dimethacrylate, glycerol dimethacrylate, hydroxypropyl methacrylate, 2-hydroxyethyl methacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, or a 2-acrylamido-2-methylpropanesulfonic acid (AMPS) derivative.

10. The method of claim 1, wherein the non-biopolymeric thickening agent comprises a copolymer of acrylamide and an acrylic acid derivative.

11. The method of claim 1, wherein the non-biopolymeric thickening agent comprises a polymer of at least one of a salt of acrylate and acrylamide.

12. The method of claim 1, wherein the non-biopolymeric thickening agent comprises a terpolymer of an acrylate salt, acrylamide and a 2-acrylamido-2-methylpropanesulfonic acid (AMPS) salt.

13. The method of claim 1, wherein the non-biopolymeric thickening agent comprises a cross-linked polyacrylic acid; a cross-linked, partially neutralized polyacrylic acid; a cross-linked, fully neutralized polyacrylic acid; or a combination thereof.

14. The method of claim 9, wherein the hydrogel is prepared from a liquid concentrate comprising:
about 28% the non-biopolymeric thickening agent and the biopolymeric thickening agent;
about 43% water;
about 23% biodegradable ester oils; and
about 6% Hypermer 2296.

15. The method of claim 9, wherein the hydrogel is prepared from a liquid concentrate comprising:
the non-biopolymeric thickening agent;
the biopolymeric thickening agent, wherein the biopolymeric thickening agent is a food grade biopolymeric thickening agent;
an edible oil, wherein the edible oil is a vegetable oil;
the surfactant, wherein the surfactant is a low HLB surfactant which is sorbitan monooleate; and
the suspending agent, wherein the suspending agent is fumed silica.

16. The method of claim 9, wherein the hydrogel is prepared from a liquid concentrate comprising:
0.1-20 wt % the biopolymeric thickening agent, wherein the biopolymeric thickening agent is starch;
30-40 wt % the non-biopolymeric thickening agent;
30-50 wt % a C₁₀₋₁₈ paraffin or a C₁₀₋₁₈ olefin;
0.5-5 wt % the surfactant, wherein the surfactant is a non-ionic surfactant; and
5-10 wt % the pH modifier, wherein the pH modifier is an alcohol amine neutralizer.

17. The method of claim 8, wherein the hydrogel is prepared from a liquid concentrate comprising:
10-15 wt % the biopolymeric thickening agent, wherein the biopolymeric thickening agent is starch;
33-38 wt % the non-biopolymeric thickening agent, wherein the non-biopolymeric thickening agent comprises an acrylic acid copolymer cross linked with a polyalkenyl polyether;
35-45 wt % C₁₄₋₁₆ paraffin or C₁₄₋₁₆ olefin;
0.5-2 wt % the surfactant, wherein the surfactant is a non-ionic surfactant comprising alkoxylated alcohol non-ionic surfactant;
5-10 wt % the pH modifier, wherein the pH modifier is an alcohol amine neutralizer comprising 2-amino-2-methly-1-propanol; and
0.1-2.5 wt % the clay, wherein the clay is smectite clay.

18. The method of claim 1, wherein the hydrogel is prepared from a liquid concentrate comprising a hydrogel forming polymer composition comprising the biopolymeric thickening agent and the non-biopolymeric thickening agent, wherein the hydrogel-forming polymer composition is capable of absorbing at least 20 times its own weight of water.

19. The method of claim 18, wherein the hydrogel is a pH-sensitive polymeric hydrogel, which becomes water-soluble or non-gelatinous as a result of a spontaneous, induced, or applied pH change.

20. The method of claim 1, wherein the hydrogel comprises a material that produces carbon dioxide upon exposure to heat, wherein the material that produces carbon dioxide comprises urea, (hydroxyalkyl)urea, mono(hydroxyethyl)urea, N,N-bis(2-hydroxyethyl)urea, tetrakis(2-hydroxyethyl)urea, tris(2-hydroxyethyl)urea, N,N-bis(2-hydroxyethyl)urea, N,N-(3-hydroxypropyl)urea, N,N-bis(4-hydroxybutyl)urea, 2-urea-2-ethyl-1,3-propanediol, saccharide ureas, 4,5-dihydroxyethylene urea, or a combination thereof.
